(19) United States
(12) Patent Application Publication
(10) Pub. No.: US 2023/0409848 A1
(43) Pub. Date: Dec. 21, 2023

(54) RFID Sender and Reader Drone Mechanism to Complete Inventory of RFID Tagged IT Assets and Data Bearing Devices

(71) Applicant: Sepehr Rajaie, Pataskala, OH (US)

(72) Inventor: Sepehr Rajaie, Pataskala, OH (US)

(21) Appl. No.: 17/748,387

(22) Filed: May 19, 2022

(51) Int. Cl. G06K 7/10; G06K 19/077

(52) U.S. Cl. CPC G06K 7/10366; G06K 19/07758

(57) ABSTRACT

The present invention is a RFID Sender and Reader Drone Mechanism to Complete Inventory of RFID Tagged IT Assets and Data Bearing Devices. This RFID sender and reader drone mechanism provides for controlled and scheduled inventory of IT assets and data bearing devices by tagging them with a unique RFID identification tag, enrolling the identification tag information into a secure and proprietary database, scheduling the RFID sender and reader drone mechanism to read all RFID identification tags within a specified area at a specified time, saving the inventory readings information into the secure and proprietary database based on date, time, and area of inventory, and allowing for review automatically by the software and review and verification of results by assigned IT personnel.

### CROSS-REFERENCES TO RELATED APPLICATIONS (IF ANY)

Not Applicable

### BACKGROUND

### 1. Field of the Invention

The present invention relates to a RFID Sender and Reader Drone Mechanism to Complete Inventory of RFID Tagged IT Assets and Data Bearing Devices.

### 2. Description of Prior Art

IT assets and data bearing devices are required to be inventoried and the process must be verified to meet cybersecurity framework regulations.

Other systems may require people to complete the inventory then compare results to previous lists which can be time consuming and incomplete. Other systems may interfere with business operations. Other systems may not be suitable for use in secure locations due to threat of loss of assets. Other systems may not have a method to locate assets if they are not in the expected location. Other systems may not work well for IT assets that are mobile and are located in different positions day to day. Other systems may not have a consistent method for tagging items. Other systems may rely on battery power to allow each tag to broadcast to centralized receiving stations. Other systems may rely on wire connection to a network to perform their function. Other systems may not have a method of saving the inventory information in a consistent fashion. Other systems may not have the information in the secure and proprietary database that is reviewed automatically by the software. Other systems may not have a method for verification of the inventory process by IT personnel. Other systems may not be changed based on the amount and type of assets to be inventoried. Other systems may not be changed based on changes in cybersecurity framework regulations.

There is still room for improvement in the art.

### SUMMARY OF THE INVENTION

The present invention is a Radio-frequency identification (“RFID”) sender and reader drone mechanism that provides for controlled and scheduled inventory of IT assets and data bearing devices by tagging them with a unique RFID identification tag, enrolling the identification tag information into a secure and proprietary database, scheduling the RFID sender and reader drone mechanism to read all RFID identification tags within a specified area at a specified time, saving the inventory readings information into the secure and proprietary database based on date, time, and area of inventory, and allowing for review automatically by the software and review and verification of results by assigned IT personnel. The RFID sender and reader drone mechanism can be scheduled to perform the inventory in an efficient manner without interfering with business operations.

Both the RFID tags and RFID sender and reader drone mechanism do not rely on wire connection to a network to perform their function. The RFID sender and reader drone mechanism may be used in secure locations with no threat of loss of assets. This RFID sender and reader drone mechanism works exceptionally well in environments where IT are mobile and are located in different positions day to day. The RFID sender and reader drone mechanism can be changed based on changes in the amount and type of IT assets to be inventoried. The RFID sender and reader drone mechanism can be changed based on changes in cybersecurity framework regulations for IT asset inventory.

It is more efficient, effective, accurate and functional than the current art.

### BRIEF DESCRIPTION OF THE DRAWINGS

Without restricting the full scope of this invention, the preferred form of this invention is illustrated in the following drawings:

FIG. 1 shows a diagram of some of the components of the invention.

### DESCRIPTION OF THE PREFERRED EMBODIMENT

There are a number of significant design features and improvements incorporated within the invention.

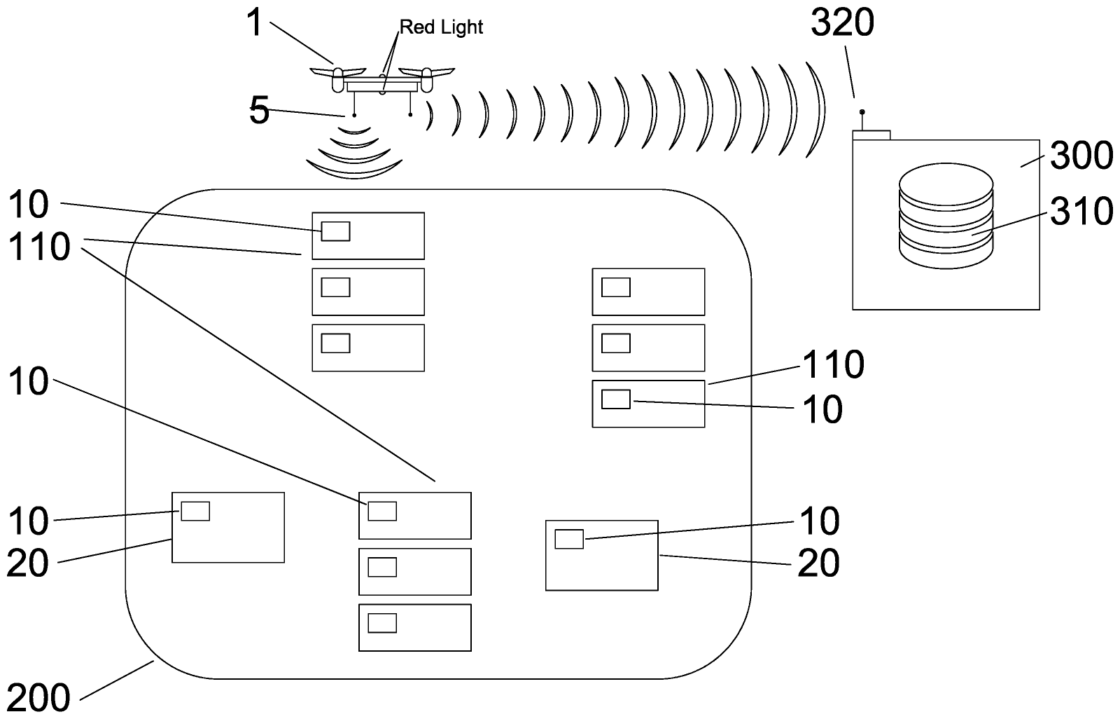

As shown in FIG. 1, the present invention is a Radio-frequency identification (“RFID”) Sender and Reader Drone Mechanism 1 to Complete Inventory of RFID Tagged IT Assets 110 and Data Bearing Devices 20.

IT assets and data bearing devices are required to be inventoried and the process must be verified to meet cybersecurity framework regulations. The invention claimed here solves this problem.

The RFID sender and reader drone mechanism 1 provides for controlled and scheduled inventory of IT assets 110 and data bearing devices 20 by tagging them with a unique RFID identification tag 10, enrolling the identification tag information into a secure and proprietary database 310 stored in non-transitory memory, scheduling the RFID sender and reader drone mechanism 1 to read all RFID identification tags 10 within a specified area 200 at a specified time, saving the inventory readings information into the secure and proprietary database 310 based on date, time, and area 200 of inventory, and allowing for review automatically by the software and review and verification of results by assigned IT personnel. The RFID sender and reader drone mechanism 1 can be scheduled to perform the inventory in an efficient manner without interfering with business operations.

Both the RFID tags 10 and RFID sender and reader drone mechanism 1 do not rely on wire connection to a network to perform their function. The RFID sender and reader drone mechanism 1 may be used in secure locations with no threat of loss of assets. This RFID sender and reader drone mechanism 1 works exceptionally well in environments where IT Assets 110 are mobile and are located in different positions day to day. The RFID sender and reader drone mechanism 1 can be changed based on changes in the amount and type of IT assets to be inventoried. The RFID sender and reader drone mechanism 1 can be changed based on changes in cybersecurity framework regulations for IT asset inventory.

The claimed invention differs from what currently exists. This RFID sender and reader drone mechanism 1 provides for controlled and scheduled inventory of IT assets 110 and data bearing devices 20 by tagging them with a unique RFID identification tag 10, enrolling the identification tag information into a secure and proprietary database 310, scheduling the RFID sender and reader drone mechanism 1 to read all RFID identification tags 10 within a specified area 200 at a specified time, saving the inventory readings information into the secure and proprietary database 310 based on date, time, and area 200 of inventory, and allowing for review automatically by the software and review and verification of results by assigned IT personnel.

The RFID sender and reader drone mechanism 1 can be scheduled to perform the inventory in an efficient manner without interfering with business operations. Both the RFID tags 10 and RFID sender and reader drone mechanism 1 do not rely on wire connection to a network to perform their function but use a wireless connection system 320. The RFID sender and reader drone mechanism 1 may be used in secure locations with no threat of loss of assets. This RFID sender and reader drone mechanism 1 works exceptionally well in environments where IT Assets 110 are mobile and are located in different positions day to day. The RFID sender and reader drone mechanism 1 can be changed based on changes in the amount and type of IT assets 110 to be inventoried. The RFID sender and reader drone mechanism 1 can be changed based on changes in cybersecurity framework regulations for IT asset 110 inventory. The RFID sender and reader drone mechanism 1 is programmed to do a complete reading of the RFID tags 10 in an area 200 at a specified date and time and save that information into the secure and proprietary database 310. This makes the inventory readings ready for review automatically by the software and review and verification by IT personnel. The verified inventory record is saved into the secure and proprietary database 310, then the verified inventory record is saved as evidence for the organization. The verified inventory record is saved as evidence for the organization, then it may be used as evidence during cybersecurity regulation audits.

The use of multiple RFID sender and reader drone mechanisms 1 can be used to complete readings of the same area 200 and date and could be scheduled to show consistent results and lower the error rate. Readings could be scheduled per worker shift for monitoring insider threat security purposes.

The drone mechanism 1 can be a flying drone or a drone that runs on the ground on wheels or a hover means.

The RFID sender and reader drone mechanism 1 will have a wireless sender and receiver 5 for sending and receiving the wireless signals using a wireless connection system 320. The wireless sender and receiver 5 will read the RFID tags 10 on the IT assets 110 and data bearing devices 20. It will either use a microprocessor within the drone mechanism 1 to store and analyze the information and/or transmits that information to the secure and proprietary database 310. The secure and proprietary database 310 would be in non-transitory memory within a computer processing device 300 such as a microprocessor on the drone, a server, a laptop or smartphone.

The RFID sender and reader drone mechanism 1 can be used by organizations that have external certification such as a formal Cyber Security Framework {CSF) that requires verification of IT assets 110 and data bearing devices 20 inventory. This RFID sender and reader drone mechanism 1 uses a certified secure and proprietary database 310 to hold information about the required inventory of IT assets 110 and data bearing devices 20. This RFID sender and reader drone mechanism 1 requires the user of the RFID sender and reader drone mechanism 1 to use unique RFID identification tags 10 to label the IT assets 110 and data bearing devices 20. The verified inventory record is saved into the secure and proprietary database 310, then the verified inventory record is saved as evidence for the organization. The verified inventory record is saved as evidence for the organization, then it may be used as evidence during cybersecurity regulation audits.

Advantages

By following the RFID sender and reader drone mechanism process, the user can be confident that IT asset inventory is completed, verified, and saved as evidence for the organization. It saves the user time and effort in completing the IT asset inventory without disruption of business operations. It reduces the insider threat in cybersecurity. This alleviates the potential problem of the user damaging their brand due to leaks of secure data onto the global network. It saves the user time and effort in security and inventory control.

It is a new method to track when equipment has maintenance performed or is otherwise unavailable in order to anticipate and schedule coverage needed for down time.

### CONCLUSION

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A device comprising:
a drone with a wireless sender and receiver that receives data from IT assets and data bearing devices that are tagged with unique RFID identification tags in a set area, and saving that data onto a secure and proprietary database in non-transitory memory.

2. The device according to claim 1 where the drone is a flying drone.

3. The device according to claim 1 where the drone has wheels.

4. The device according to claim 1 where the drone has a hover means.

5. The device according to claim 1 where the drone has a microprocessor to receive data from tagged IT assets and data bearing devices and save that data onto a secure and proprietary database in non-transitory memory.

6. A process comprising;
having a drone with a wireless sender and receiver;
tagging IT assets and data bearing devices with unique RFID identification tags;
entering identifying information and RFID tag information for each tagged IT asset and data bearing device into the secure and proprietary database;
having the IT assets and data bearing devices in a defined area;
having the drone read the unique RFID identification tags to complete an inventory of a specified area, date, and time for all RFID tagged items;
sending and saving inventory information into the secure and proprietary database
and
using a system for review of information provided by RFID sender and reader drone mechanism automatically by the software and review and verification by assigned IT personnel.

7. A system according to claim 6 where IT assets and data bearing devices are tagged with unique RFID identification tags

8. A system according to claim 6 for entering identifying information and RFID tag information for each tagged IT asset and data bearing device into the secure and proprietary database.

9. A system according to claim 6 for having the IT assets and data bearing devices in a defined area.

10. A system according to claim 6 for having a drone with a wireless sender and receiver.

11. A system according to claim 6 for having the drone read the unique RFID identification tags to complete an inventory of a specified area, date, and time for all RFID tagged items.

12. A system according to claim 6 for having the drone with a wireless sender and receiver send and save inventory information into the secure and proprietary database.

13. A system according to claim 6 for using a system for review of information provided by RFID sender and reader drone mechanism automatically by the software.

14. A system according to claim 6 for using a system for review of information provided by RFID sender and reader drone mechanism for review and verification by assigned IT personnel.

15. A system according to claim 6 for having the verified inventory record saved into the secure and proprietary database as evidence for the organization.
